(19) United States
(12) Patent Application Publication
(10) Pub. No.: US 2011/0047313 A1
(43) Pub. Date: Feb. 24, 2011

(54) Memory area network for extended computer systems

(76) Inventors: Joseph Hui, Fountain Hills, AZ (US); David A. Daniel, Scottsdale, AZ (US); Tim Jeffries, Scottsdale, AZ (US)

Correspondence Address: Law Office of ROBERT C. KLINGER, 2591 Dallas Parkway, Suite 300, FRISCO, TX, 75034, US

(21) Appl. No.: 12/589,448

(22) Filed: Oct. 23, 2009

Related U.S. Application Data
(60) Provisional application No. 61/197,100, filed on Oct. 23, 2008.

(51) Int. Cl. G06F 13/36; G06F 13/00

(52) U.S. Cl. 710/314; 710/316

(57) ABSTRACT

A solution enabling the practical use of very large amounts of memory, external to a host computer system. With physical locality and confinement removed as an impediment, large quantities of memory, here before impractical to physically implement, now become practical. Memory chips and circuit cards no longer must be installed directly in a host system. Instead, the memory resources may be distributed or located centrally on a network, asconvenient, in much the same manner that mass storage is presently implemented.

### CLAIM OF PRIORITY

This application claims priority of U.S. Provisional Ser. No. 61/197,100 entitled “A MEMORY AREA NETWORK FOR EXTENDED COMPUTER SYSTEMS” filed Oct. 23, 2008, the teachings of which are incorporated herein by reference.

### FIELD OF THE INVENTION

The present invention relates to computer expansion and virtualization via high speed data networking protocols and specifically to techniques for creating and managing shared global memory resources.

### BACKGROUND OF THE INVENTION

There is growing acceptance of techniques that leverage networked connectivity for extending the resources of host computer systems. In particular, networked connectivity is being widely utilized for specialized applications such as attaching storage to computers. For example, iSCSI makes use of TCP/IP as a transport for the SCSI parallel bus to enable low cost remote centralization of storage.

PCI Express, as the successor to PCI bus, has moved to the forefront as the predominant local host bus for computer system motherboard architectures. PCI Express allows memory-mapped expansion of a computer. A cabled version of PCI Express allows for high performance directly attached bus expansion via docks or expansion chassis.

A hardware/software system and method that collectively enables virtualization and extension of its memory map via the Internet, LANs, WANs, and WPANs is described in commonly assigned U.S. patent application Ser. No. 12/148,712 and designated “i-PCI”, the teachings of which are included herein.

The i-PCI solution is a hardware, software, and firmware architecture that collectively enables virtualization of host memory-mapped I/O systems. The i-PCI protocol extends the PCI I/O System via encapsulation of PCI Express packets within network routing and transport layers and Ethernet packets and then utilizes the network as a transport. For further in-depth discussion of the i-PCI protocol see commonly assigned U.S. patent application Ser. No. 12/148,712, the teachings which are incorporated by reference.

It is desirable to have some portion of memory-mapped resources distributed outside the computer and located in pools on a network or the Internet, such that the memory may be shared and addressable by multiple clients.

### SUMMARY OF THE INVENTION

The invention achieves technical advantages as a system and method including new classes—or “tiers”—of solid state addressable memory accessible via a high data rate Ethernet or the Internet. One aspect of the invention, simply stated another way, is the provision of addressable memory access via a network.

The invention is a solution enabling the practical use of very large amounts of memory, external to a host computer system. With physical locality and confinement removed as an impediment, large quantities of memory, here before impractical to physically implement, now become practical. Memory chips and circuit cards no longer need be installed directly in a host system. Instead, the memory resources may be distributed or located centrally on a network, as convenient.

In one embodiment, the invention leverages i-PCI as the foundational memory-mapped I/O expansion and virtualization protocol and extends the capability to include shared global memory resources. The net result is unprecedented amounts of collective memory—defined and managed in performance tiers—available for cooperative use between computer systems.

### BRIEF DESCRIPTION OF THE DRAWINGS

FIG. 1 depicts using the Internet as a means for extending a computer system's native bus via high speed networking;

FIG. 2 is a list of the various tiers of memory, arranged from highest performance to lowest performance;

FIG. 3 is an illustration of where various tiers of memory may be found in a networked computing environment;

FIG. 4 is a revised illustration of where three new tiers of computer memory may be found as a result of the invention;

FIG. 5 depicts a block diagram of the i-PCI Host Bus Adapter;

FIG. 6 depicts a block diagram of the i-PCI Remote Bus Adapter;

FIG. 7 shows a PCI-to-network address mapping table to facilitate address translation;

FIG. 8 shows the major functional blocks of the Resource Cache Reflector/Mapper;

FIG. 9 shows an example 64-bit memory map for a host system;

FIG. 10 is a block diagram of the memory card utilized by the invention; and

FIG. 11 is an illustration showing how the remote I/O expansion chassis and solid state memory cards fit into to the overall memory scheme of the invention.

### DETAILED DESCRIPTION OF THE PRESENT INVENTION

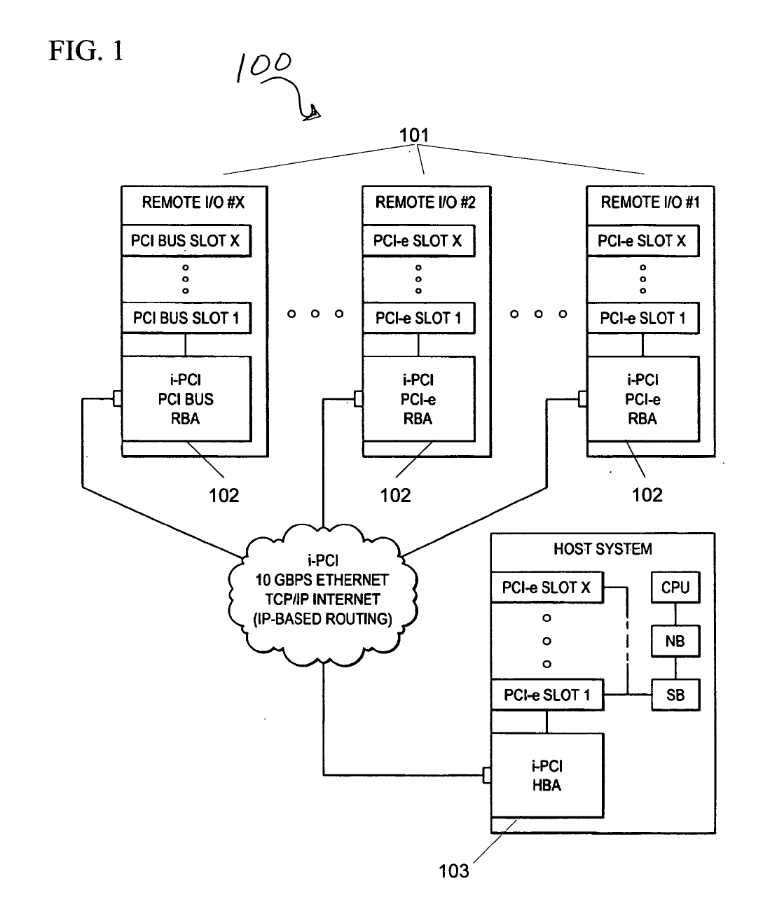

Referring to FIG. 1, there is shown an overview of iSCSI, PCI Express, i-PCI as a backdrop, and the computer system memory organization according to one aspect of the invention.

Data in a given computer system 100 is typically written and read in organized tiers of memory devices. These tiers are arranged according to the speed and volume with which data has to be written or read.

At one extreme of high speed and small volume, a Computer Processing Unit (CPU) employs on-chip cache registers and fast memory for storing small data units (multiple bytes) which move in and out of the CPU rapidly (sub-nanosecond speed).

The next lower tier involves programs and data that are stored in solid state memory (typically DRAM) utilized by the CPU and referenced in terms of the memory address space. This data is often accessed in a size of tens of bytes and at nanosecond speed.

In the mid-tier range, memory-mapped computer peripheral cards are found, where memory is tightly coupled to the CPU via onboard computer I/O buses such as PCI and PCI Express.

As utilization moves to the lower tiers, it involves mass data stored in electro-mechanical storage devices such as hard disk drives (HDDs). Disk arrays are often used, interconnected by parallel cables such as SCSI or by serial interfaces such as SATA. Since data is stored in a spinning magnetic storage medium, access speed is typically in milliseconds. The data is addressed in blocks of size exceeding one hundred bytes.

For very large storage requirements, arrays of distributed disk storage are often deployed. In the scenario of Direct Attached Storage (DAS), a short external cabled bus such as a SCSI or USB allows multiple hard disks to be located outside a computer.

In the scenario of Storage Area Network (SAN), such as a Fibre Channel network, a large number of hard drives may be distributed in multiple storage arrays, interconnected by local transmission links and switches and accessible by multiple clients. The clients of this mass storage access the storage server to retrieve data.

iSCSI is another example of a SAN application. In the case of iSCSI, data storage may be distributed over a wide area through a Wide Area Network (WAN). The Internet-SCSI (iSCSI) protocol encapsulates SCSI format data in Internet Protocol (IP) datagrams, which are then transported via the global Internet.

The lowest tier is utilized for storage and retrieval of larger data units such as files of Megabyte size at much lower speed (i.e. seconds). The Network File Server (NFS) is an example of a protocol for file retrieval over LANs and the Internet. Hard disks are the typical storage medium, but other slower speed medium such as magnetic tape may also be used. This very low tier of storage typically is used for archival purposes when huge volume of data is stored but retrieved very infrequently.

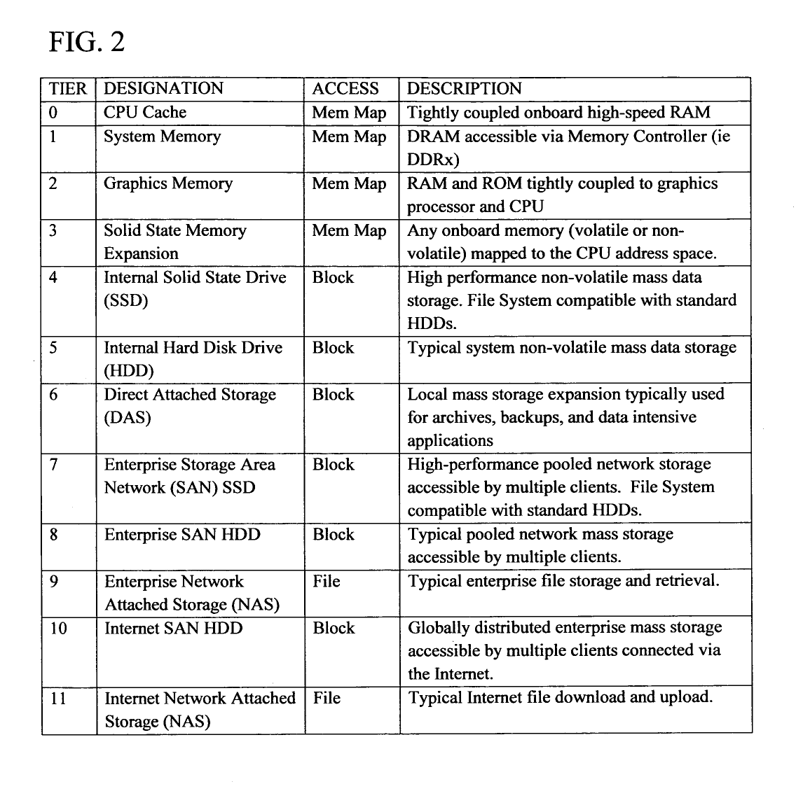

FIG. 2 shows a list of the various Tiers, arranged from highest performance to lowest performance, with Tier 0 being the highest performance.

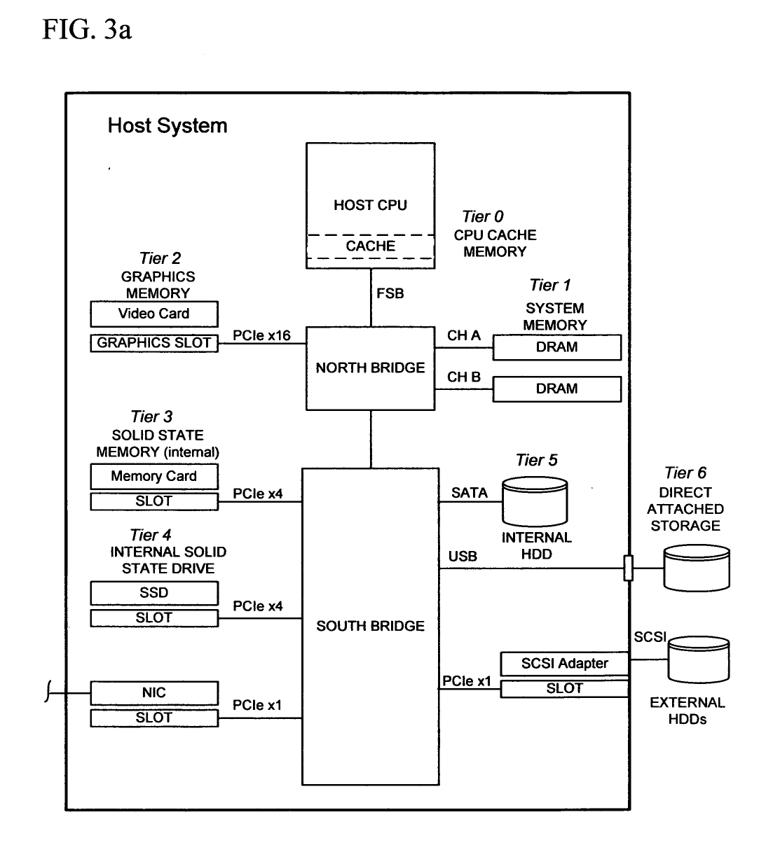

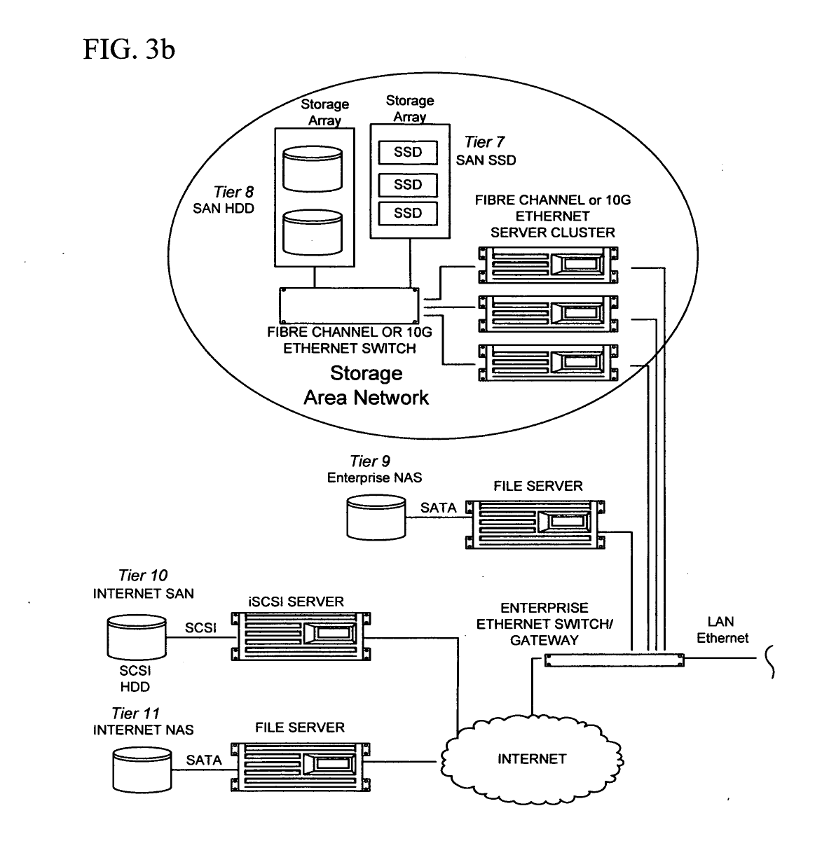

FIG. 3 is an illustration of where the various tiers may be found in a networked computing environment.

It may be observed, in reviewing the various tiers of memory that the only type of memory access across the Ethernet network is block access or file access. Conventionally, the problem is there is presently no practical memory mapped access solution beyond the host. Addressable memory has several advantages, including much finer granularity of data manipulation. With memory-mapped access, byte level manipulation and transactions are possible.

As 32-bit processors and operating systems give way to 64-bit systems, the associated memory map expands from 2\hat{0}32=4 gigabyte of addressable memory space to 2\hat{0}64=16 Exabyte of addressable memory space. Thus, a tremendous amount of addressable memory is now possible. With this huge amount of memory potential available to the CPU, it is no longer technically necessary to assign mass storage to disk drives which limit the CPU to block or file level access.

Conventional computing directly attaches solid state memory to a computer through various internal buses such as PCI. The present invention advantageously provides “Memory Area Network (MeMAN)” in which multiple devices with solid state memory are distributed over an area accessible by multiple computers also distributed over an area, with these memory devices and computers interconnected via transmission links and switches.

MeMAN advantageously enables accessing or storing data over a wide area directly, using computer memory addressing. Thus, multiple computers may access multiple devices containing solid state memory via long distance transmission and via switching techniques, such as those techniques implemented for Ethernet, the Internet, or any other computer bus adapted for extended distances. MeMAN maps memory addresses onto other types of addresses, including and not limited to Ethernet addresses, IP addresses, addresses for transmitting and switching devices, as well as other types of hardware addresses—using novel techniques according to one aspect of the present invention.

One solution enabled by MeMAN is summarized as: A plurality of solid state memory devices and a plurality of computer servers may be interconnected over a wide area using longer distance transmission and switching means than possible using a local computer bus. Thus, memory can be pooled on a network and shared by multiple computer servers allowing for flexible, scalable, and reliable memory mapping and sharing.

There are several key aspects of MeMAN:

1. Fast, reliable and high volume transmission and switching of data over a wide area.

2. The ability to access data directly using memory addressing, instead of other types of access such as the block addressing used with disk drive mass storage, or network addressing used with such protocols as IP or Ethernet. An adaptation layer translates the memory address of data into the requisite means of data transport addressing, such as IP addresses, Ethernet addresses, or other types of device addresses.

3. Data delay and throughput requirements are considered in regards to memory access in that such access is made over a wider area than the internal memory data bus of a computer device.

MeMAN results in at least three new tiers of computer memory:

1. Memory-mapped computer memory located as Directly Attached Memory. This is located between Tiers 3 and 4 in FIG. 2.

2. Memory-mapped computer memory located on an Enterprise LAN. This is located between Tiers 6 and 7 in FIG. 2.

3. Memory-mapped computer memory located on the Internet. This is located between Tiers 9 and 10 in FIG. 2.

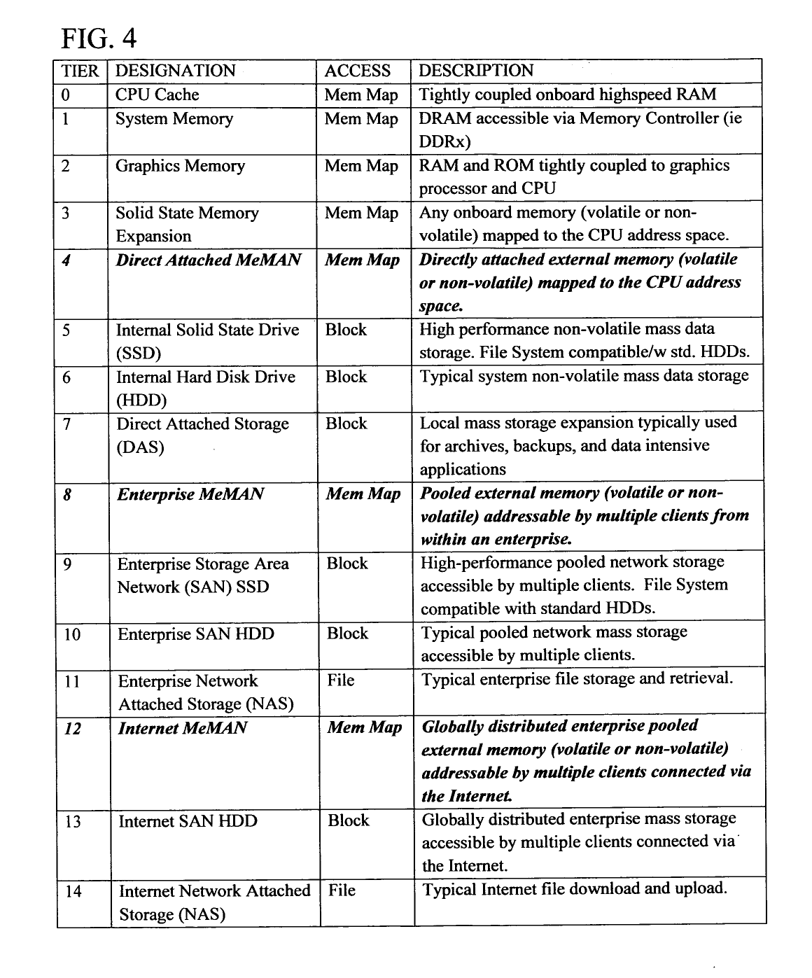

The resulting revised Memory Tiers are shown in FIG. 4.

In one preferred embodiment, MeMAN utilizes Internet PCI (i-PCI), Ethernet-PCI (i(e)-PCI), or direct-connect-PCI (i(dc)-PCI) technology introduced in commonly assigned U.S. patent application Ser. No. 12/148,712. This patent application teaches and describes a hardware/software system, designated “i-PCI” that collectively enables virtualization of the host computer's native I/O system architecture via the Internet and LANs. i-PCI allows devices native to the host computer native I/O system architecture—including bridges, I/O controllers, and a large variety of general purpose and specialty I/O cards—to be located far afield from the host computer, yet appear to the host system and host system software as native system memory or I/O address mapped resources. The end result is a host computer system with unprecedented reach and flexibility through utilization of LANs and the Internet.

One basic idea of i-PCI is to extend the PCI I/O System via encapsulation of PCI Express packets within TCP/IP and/or Ethernet packets and then utilize the Internet or LAN as a transport. Advantageously, the network is made transparent to the host and thus the remote I/O appears to the host system as an integral part of the local PCI System Architecture. The result is a “virtualization” of the host PCI System. FIG. 1 shows a host system 100 connected to multiple remote expansion chassis 101. A Host Bus Adapter (HBA) 103 installed in a host PCI Express slot interfaces the host to the Internet or LAN. A Remote Bus Adapter (RBA) 102 interfaces the remote PCI Express bus resources to the LAN or Internet.

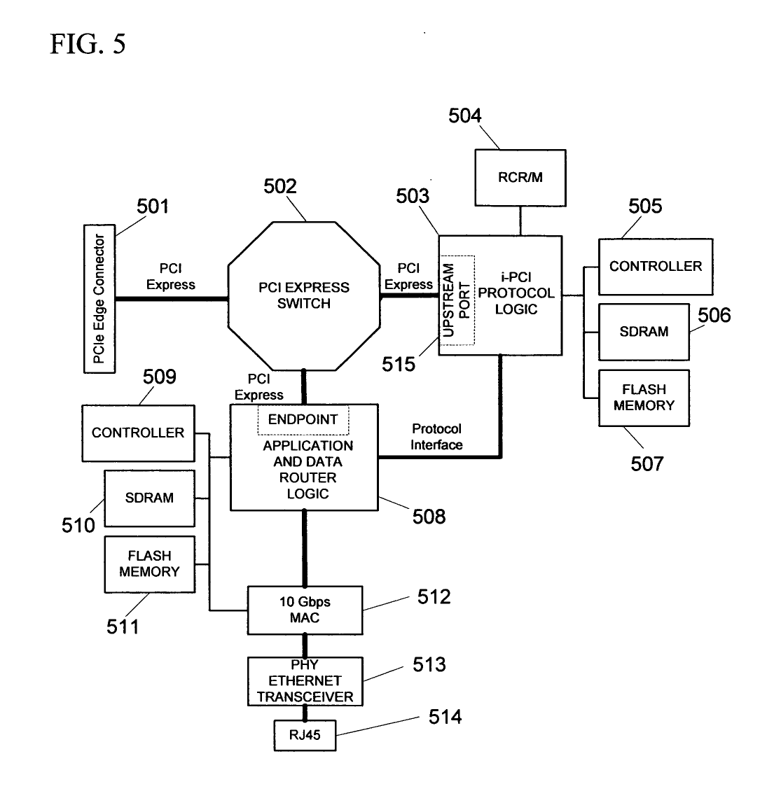

The HBA major functional blocks are depicted in FIG. 5. The HBA design includes a PCI Express edge connector 501, a PCI Express Switch 502, i-PCI Protocol Logic 503, the Resource Cache Reflector/Mapper 504; Controller 505, SDRAM 506 and Flash memory 507 to configure and control the i-PCI Protocol Logic; Application and Data Router Logic 508; Controller 509, SDRAM 510 and Flash memory 511 to configure and control the Application and Data Router Logic and 10 Gbps MAC 512; PHY 513, and connection to the Ethernet 514.

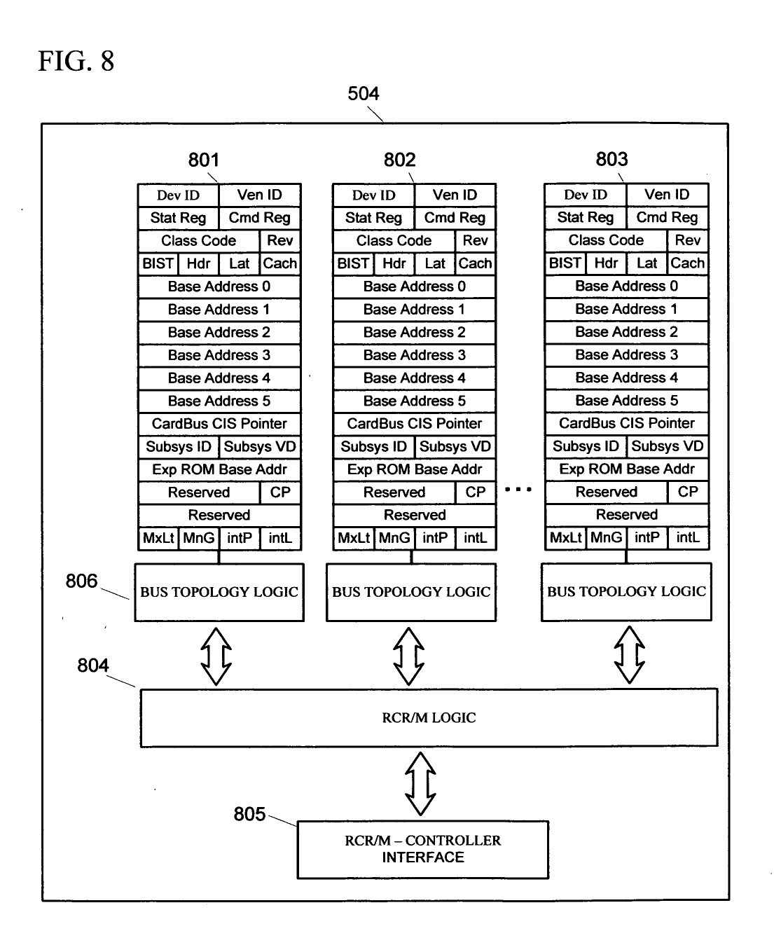

Referring to FIG. 8, the RCR/M 504 is resident in logic and nonvolatile read/write memory on the HBA. The RCR/M consists of an interface 805 to the i-PCI Protocol Logic 503 for accessing configuration data structures. The data structures 801, 802, 803 contain entries representing remote PCI bridges and PCI device configuration registers and bus segment topologies 806. These data structures are pre-programmed via an application utility. Following a reboot, during enumeration the host BIOS “discovers” these entries, interprets these logically as the configuration space associated with actual local devices, and thus assigns the proper resources to the mirror.

The HBA and Remote Bus Adapter (RBA) together form a virtualized PCI Express switch. The virtualized switch is disclosed in commonly assigned U.S. patent application Ser. No. 12/286,796, the teachings of which are included herein by reference.

Each port of a virtualized switch can be located physically separate. The HBA implements the upstream port 515 via a logic device such as a FPGA. The RBAs—located at up to 32 separate expansion chassis 101—may include a similar logic device onboard with each of them implementing a corresponding downstream port 614. The upstream and downstream ports are interconnected via the Ethernet network, forming a virtualized PCI Express switch.

The Ethernet network may optionally be any direct connect, LAN, WAN, or WPAN arrangement as defined by i-PCI.

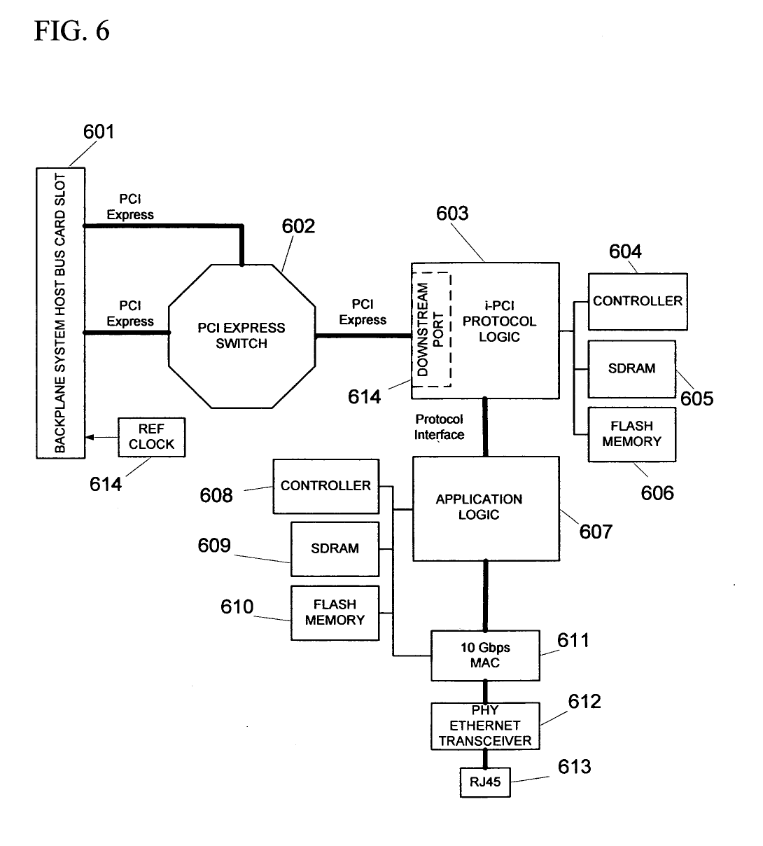

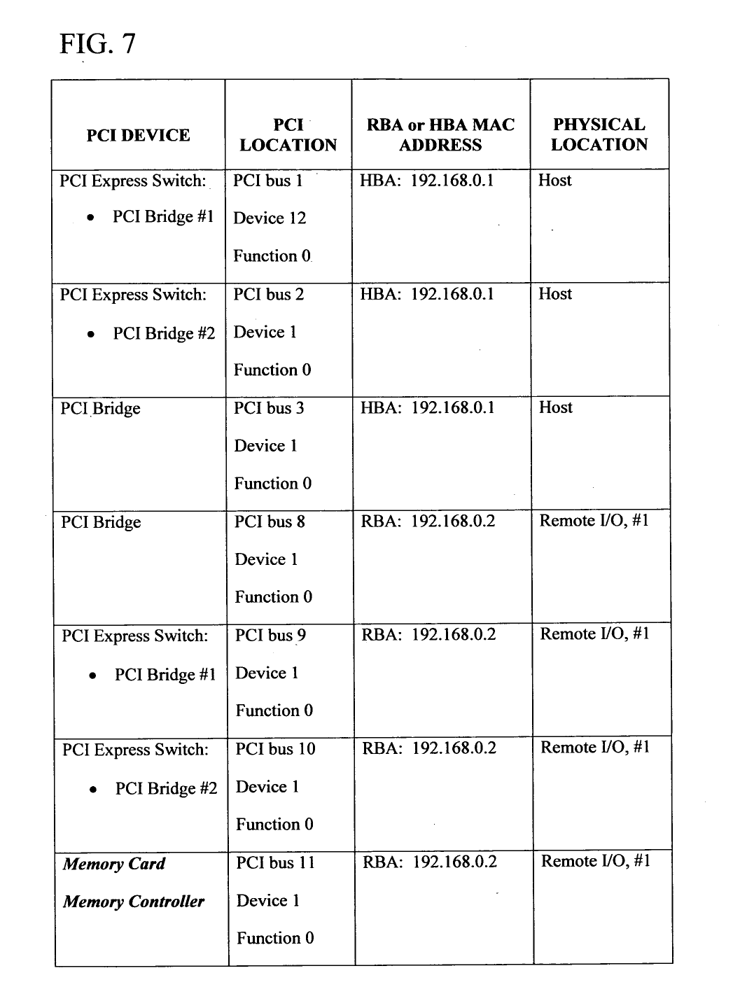

Referring to FIG. 1 and FIG. 6, the RBA 102 is functionally similar to the HBA 103. The primary function of the RBA is to provide the expansion chassis with the necessary number of PCI Express links to the PCI Express card slots and a physical interface to the Ethernet network. PCI Express packet encapsulation for the functions in the expansion chassis is implemented on the RBA. The RBA supports the HBA in ensuring the host remains unaware that the PCI and/or PCI Express adapter cards and functions in the expansion chassis are not directly attached. The RBA assists the HBA with the host PCI system enumeration and configuration system startup process. The RBA performs address translation for the PCI and/or PCI Express functions in the expansion chassis, translating transactions moving back and forth between the blade and the expansion chassis via the network. It also includes a PCI-to-network address-mapping table. See FIG. 7. Data buffering and queuing is also implemented in the RBA to facilitate flow control at the interface between the Expansion Chassis PCI Express links and the network. The RBA provides the necessary PCI Express signaling for each link to each slot in the expansion chassis.

The RBA major functional blocks are depicted in FIG. 6. The RBA design includes a Backplane System Host Bus interface 601, a PCI Express Switch 602, i-PCI Protocol Logic 603; Controller 604, SDRAM 605 and Flash memory 606 to configure and control the i-PCI Protocol Logic; Application Logic 607; Controller 608, SDRAM 609 and Flash memory 610 to configure and control the Application Logic and MAC 611; PHY 612, and connection to the Ethernet 613.

For MeMAN, the Remote I/O 101 is populated with solid state memory cards. The solid state memory cards are enumerated by the client system and appear as PCI Express addressable memory to the client computer. Note that these memory cards do not appear to the system as disk drives—they appear as memory-mapped resources.

PCI Express supports 64-bit addressing; however, for MeMAN, the bridges in the data transfer path must all support prefetchable memory on the downstream side. A Solid State Memory Card is seen as a prefetchable memory target and the configuration software assigns a sub-range of memory addresses to the card, within the 2̂64 memory space. The memory could be of any addressable type, including NOR-type Flash, ROM, or RAM.

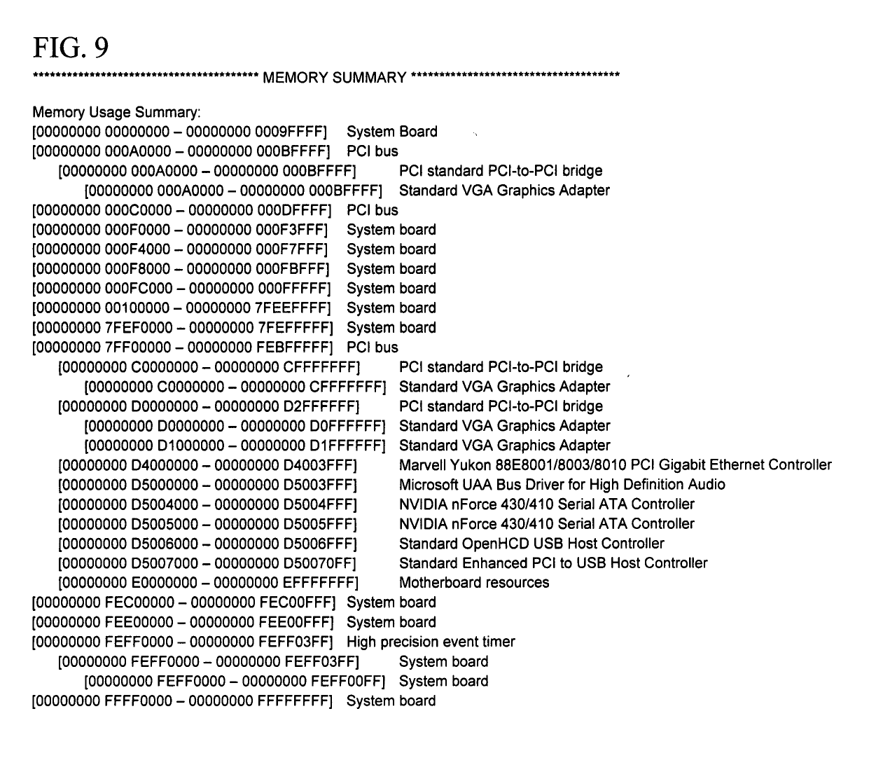

FIG. 9 shows an example 64-bit memory map for a host system. In this example the host system resources are all assigned within the lower 32-bit (4 GB) memory space (0000000-FFFFFFFF). If this system were to implement MeMAN, unused memory space above the 4 GB could be mapped as prefetchable memory.

If a given expansion chassis were populated with 10 memory cards, each of which provides 1 Terabyte (1000 GB) of memory, the address space required would be 10 Terabytes. This 10 Terabytes may be assigned a segment of prefetchable memory, beginning at the 4 G boundary from 100000000h-9C500000000h as follows:

Memory Card 1: 0000000100000000-000000FAFFFFFFFF

Memory Card 2: 000000FB00000000-000001F4FFFFFFFF

Memory Card 3: 000001F500000000-000002EEFFFFFFFF

Memory Card 4: 000002EF00000000-000003E8FFFFFFFF

Memory Card 5: 000003E900000000-000004E2FFFFFFFF

Memory Card 6: 000004E300000000-000005DCFFFFFFFF

Memory Card 7: 000005DD00000000-000006D6FFFFFFFF

Memory Card 8: 000006D700000000-000007DOFFFFFFFF

Memory Card 9: 000007D100000000-000008CAFFFFFFFF

Memory Card 10: 000008CB00000000-000009C4FFFFFFFF

For MeMAN, the i-PCI I/O expansion chassis memory may be enabled for multiple client access. A memory controller, configured to support MeMAN, allows clients to map the chassis memory within their respective address space.

In one preferred embodiment, the MeMAN memory card utilizes non-volatile NOR Flash components. The NOR Flash implements a bit/byte addressable parallel interface. This NOR parallel interface allows computers and microprocessors to use it as “execute-in-place” memory. That is, advantageously, the contents do not need to be relocated to RAM for use by the host machine as is the case with drive technologies and block-oriented flash technologies. Execute-in-place NOR flash memory components are available from various manufacturers and in various technologies. One example of this technology suitable for MeMAN is referred to in industry and literature as “Phase Change Memory” (PCM).

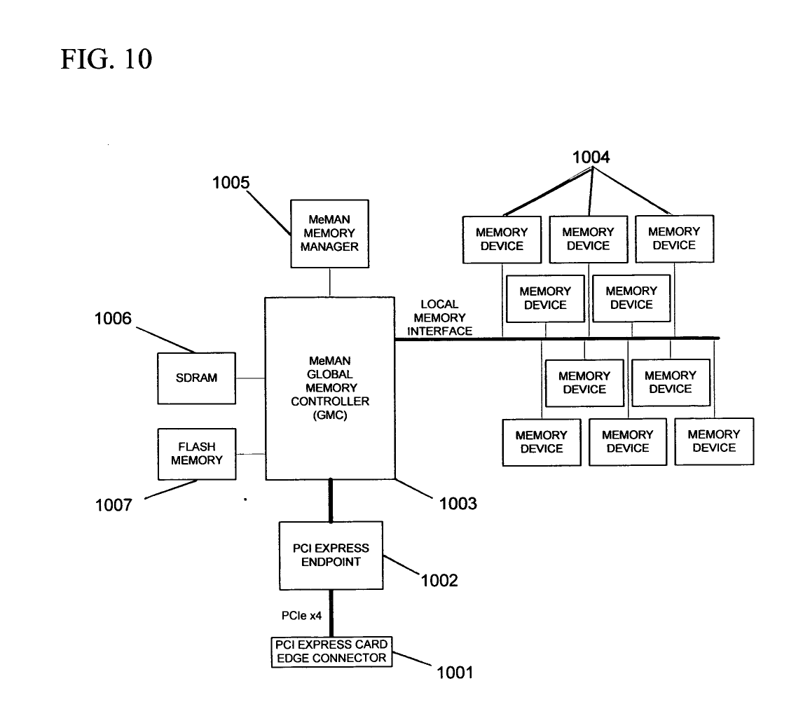

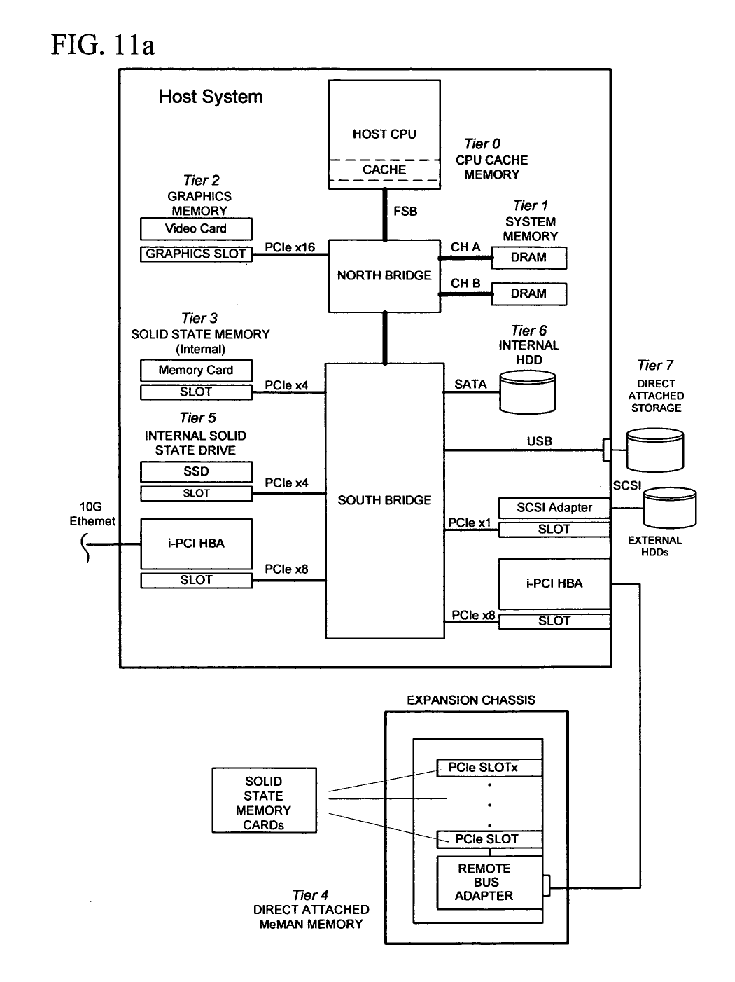

Referring to FIG. 10, the major functional blocks for the MeMAN memory card consists of a PCI Express edge connector 1001 which connects to the remote I/O 102 PCIe slot, a PCI Express endpoint 1002 that implements a memory controller class code configuration space, a MeMAN Global Memory Controller (GMC) 1003 which controls the read/write access to the collective memory resources on the card 1004, MeMAN Memory Manager 1005 responsible for control/configuration/status for the memory card, a small amount of SDRAM 1006 for use as necessary by the Memory Manager, and a small amount of non-volatile flash memory 1007 for Memory Manager program storage.

The memory address range for a card may be configured to be exclusive to one client or the memory address range may be mapped to multiple clients, such that collaboration or parallel processing of data may occur. In the case where the same memory address range is mapped to multiple clients, any number of multiprocessor memory space sharing schemes may be employed by the GMC and configured by the Memory Manager.

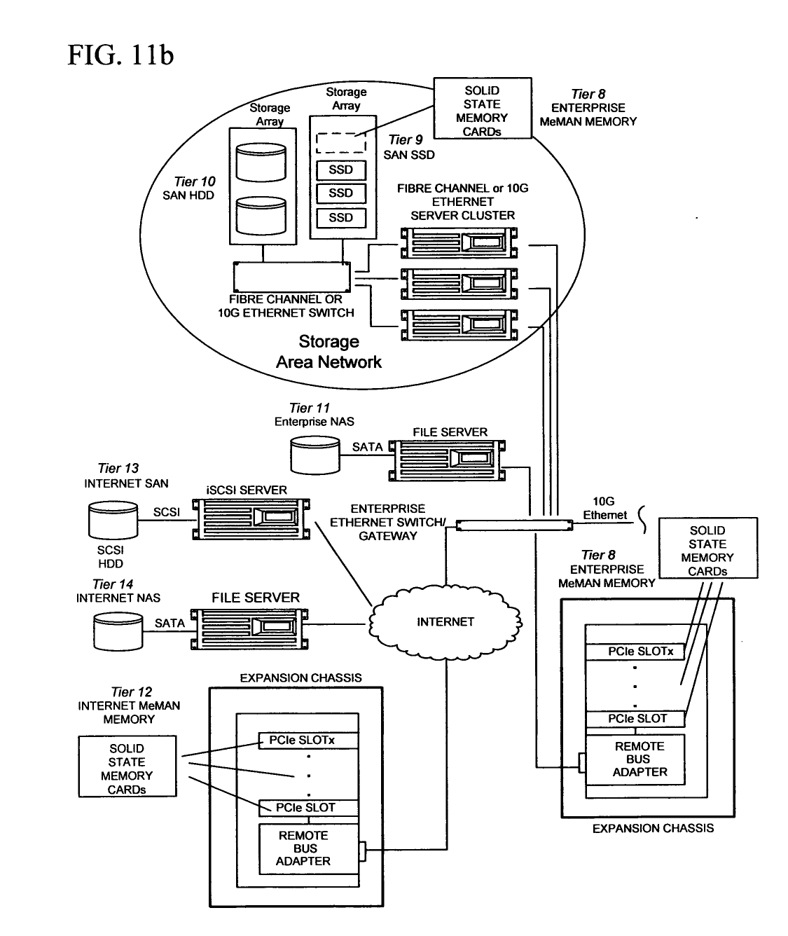

In 10 G Ethernet SAN implementations, the memory card could be integrated into vendor enterprise storage arrays (such as those available from companies such as EMC, HDS, and IBM) as opposed to a separate remote I/O expansion chassis. These storage arrays can utilize the i-PCI RBA as a standard 10 G Ethernet adapter card interface to the SAN, but with the additional benefit of including the i-PCI protocol. This enables access to the high-performance universal pool of solid state addressable storage located on the memory card within the storage array. This pool of memory is accessible by servers and their applications through the 10 G Ethernet. FIG. 11, is an illustration of the end result of the invention, showing how MeMAN results in the additional tiers of memory.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

What is claimed is:

1. A device, comprising:
a module comprising a memory mapped resource configured to enable multiple memory devices with solid state computer addressable memory to be distributed over an area and be accessible by multiple computers, wherein the memory devices and the computers are operably interconnected via transmission links and switches.

2. The device as specified in claim 1, where the memory mapped resource is not at the block or file level.

3. The device as specified in claim 1, where the memory mapped resource is byte or bit oriented and operably compatible with the PCI or PCI Express protocol.

4. The module as specified in claim 1, wherein the memory mapped resource is configured to enable the plurality of solid state memory devices and a plurality of computer servers to be operably interconnected over a wide area using longer distance transmission and switching means than possible using a local computer bus.

5. The module as specified in claim 1, wherein the memory mapped resource is configured to enable long distance transmission and utilize switching techniques, the techniques selected from the group of: Ethernet, Internet, and a computer bus adapted for extended distances.

6. The module as specified in claim 5 wherein the memory mapped resource is configured to utilize i-PCI as a foundational enabling memory-mapped I/O expansion and virtualization protocol.

7. The module as specified in claim 4 wherein the memory resource is configured to enable computer memory addresses to mapped onto other types of addresses, including Ethernet addresses, IP addresses, addresses for transmitting and switching devices, and hardware.

8. The module as specified in claim 1 wherein the memory resource is configured to enable computer addressable memory to be pooled on a network and shared by multiple computer servers via memory-mapped access to enable flexible, scalable, and reliable memory mapping and sharing.

9. The module as specified in claim 1, wherein solid state computer addressable memory is located as Directly Attached Memory.

10. The mechanism as specified in claim 1, wherein the solid state computer addressable memory is located on an Ethernet.

11. The module as specified in claim 1, wherein the solid state computer addressable memory is located on the Internet.

12. The module as specified in claim 5 wherein the memory mapped resource is configured to operably utilize an Ethernet network comprising a direct connect, LAN, WAN, or WPAN arrangement or any combination thereof.

13. The module as specified in claim 1 wherein the memory mapped resource is configured to encapsulate PCI Express packets within TCP/IP and/or Ethernet packets.

14. The module as specified in claim 1 wherein the memory mapped resource is configured to categorize different types of the memory device memories into tiers.

15. The module as specified in claim 14 wherein the memory mapped resource is configured to operably interconnect one said computer with one said memory device as a function of the memory device tier.

16. The module as specified in claim 14 wherein the module is configured as a host bus adapter.

17. The module as specified in claim 1 wherein the memory devices are configured to be enumerated by a client system and appear to the computer as PCI Express addressable memory.

18. The module as specified in claim 13 wherein the module is configured to enable virtualization of the computer's native I/O system architecture via the Internet and LANs.

19. The module as specified in claim 1 wherein the module is configured to enable the computer to access data from one of the memory devices directly using memory addressing,

20. The module as specified in claim 19 wherein the module further includes an adaptation layer configured to translate a memory address of data by one said computer into requisite means of data transport addressing, including IP addresses and Ethernet addresses.
